(19) United States
(12) Patent Application Publication
(10) Pub. No.: US 2011/0073441 A1
(43) Pub. Date: Mar. 31, 2011

(54) Conveyor module

(76) Inventor: Christopher Dale, Studley (GB)

(21) Appl. No.: 12/927,894

(22) Filed: Nov. 29, 2010

Related U.S. Application Data
(62) Division of application No. 12/288,608, filed on Oct. 22, 2008.
(60) Provisional application No. 60/981,931, filed on Oct. 23, 2007.

(51) Int. Cl. B65G 21/00

(52) U.S. Cl. 198/617

(57) ABSTRACT

A conveyor module to necessitate cleaning and maintenance. The endless conveyor belt tension is released by removing the side plates and pivoting the idler roller mounts. The belt may be removed for cleaning underneath and tightened by pivoting the idler roller mounts to their normal operating position. Further maintenance can be performed by removing the entire upper conveyor belt section from the conveyor subframe by releasing one or more retaining fingers.

### CROSS-REFERENCE TO RELATED APPLICATIONS

This is a division of application Ser. No. 12/288,608, Filed 2008 Oct. 22, now abandoned. This divisional application claims the benefit of provisional patent application Ser. No. 60/981,931, Filed 2007 Oct. 23 by the present inventor.

### FEDERALLY SPONSORED RESEARCH

Not Applicable

### SEQUENCE LISTING OR PROGRAM

Not Applicable

### BACKGROUND

1. Field

This application relates to a system of conveying items, specifically a system used to convey articles to a combination weigher prior to the articles entering a bag making machine.

2. PRIOR ART

Several methods of conveying products, particularly food products, to package into bags have been developed. Feeding devices such as the vibrating feeder in U.S. Pat. No. 5,074,436 to Inoue (1991) are not suited to feeding sticky food product. Other attempts to accurately feed weighers have been attempted as in U.S. Pat. No. 4,765,488 to Moriarity (1988). Moriarity uses a non-plurality of conveyors to feed multiple hoppers causing a bottle-neck or decrease in feed rate. Additionally, little is taught of actual construction of the conveyor.

U.S. Pat. No. 7,806,254 to Brayman (2010) and U.S. Pat. No. 5,022,514 to Lofberg (1991) allow for conveyor belt removal but pivot the idler in the downward direction. This orientation may cause the belt to self-loosen if the direction of travel is over the top of the idler roller.

U.S. Pat. No. 3,456,776 to Viene (1969) and U.S. Pat. No. 7,549,531 to Hosch (2009) teach of methods of loosening a conveyor belt to allow for cleaning, but have side structural members that prevent the removal of the belt once the idler roller is pivoted from its normal position.

### SUMMARY

In accordance with one embodiment, the conveyor module may be removed for maintenance or cleaning using a self-locking mechanism to hold the conveyors in place relative to the support frame. Additionally, the conveyor belt may be quickly removed by pivoting the idler roller of the conveyor thereby removing belt tension.

### DRAWINGS—FIGURES

FIG. 1 shows a view of a conveyor module locked in place to the subframe assembly in accordance with one embodiment.

FIG. 2 is a view of the bottom of a conveyor module locked in place to the subframe assembly in accordance with one embodiment.

FIG. 3 is a view of a conveyor module removed from the subframe assembly in accordance with one embodiment.

FIG. 4 is a view of the bottom of a conveyor module removed from the subframe assembly in accordance with one embodiment.

FIG. 5 is a more detailed view of the conveyor module subframe assembly in accordance with one embodiment.

### DRAWINGS—REFERENCE NUMERALS

| | |
|---|---|
| 1 conveyor belt | 2 side walls |
| 3 ends | 4 driven roller |
| 5 conveyor side plates | 6 idler roller |
| 7 pivoting roller mount | 8 product guard |
| 9 slots | 10 short retaining shafts |
| 11 long retaining shafts | 12 machined slots |
| 13 conveyor subframe | 14 retaining fingers |

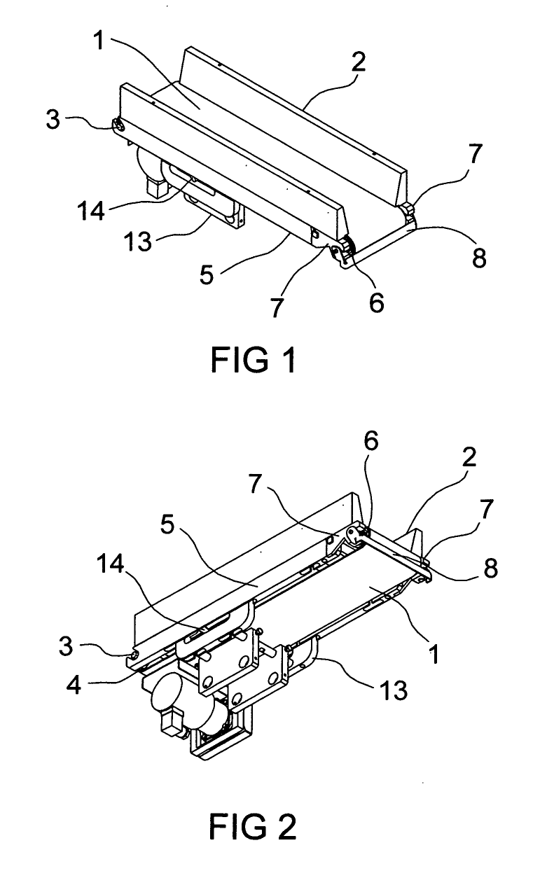

### DETAILED DESCRIPTION—FIGS. 1 AND 2—FIRST EMBODIMENT

FIGS. 1-2 illustrate detailed views of the construction of one embodiment of a conveyor. Since many food packaging facilities place a high emphasis on cleanliness of machinery, it is essential that the conveyor module be easily cleaned and maintained.

To change or clean the conveyor belt 1 the side walls 2 of the conveyor are lifted from vertical retaining pins (not shown) and set aside. The opposing ends 3 of the conveyor driven rollers 4 are slidably accepted into one end of the conveyor side plates 5. The opposing ends 3 of the idler roller 6 are slidably accepted into one end of the pivoting roller mount 7. When the pivoting roller mount 7 is rotated past its over center position, the tension is released in the conveyor belt 1 to allow removal or cleaning under the conveyor belt 1. When the conveyor belt 1 is reinstalled, the pivoting roller mount 7 is rotated back slightly past its over center position effectively locking the idler roller 6 in its position using tension from the conveyor belt 1. The exit end of the conveyor also contains a product guard 8 to keep food products from passing under the conveyor belt 1.

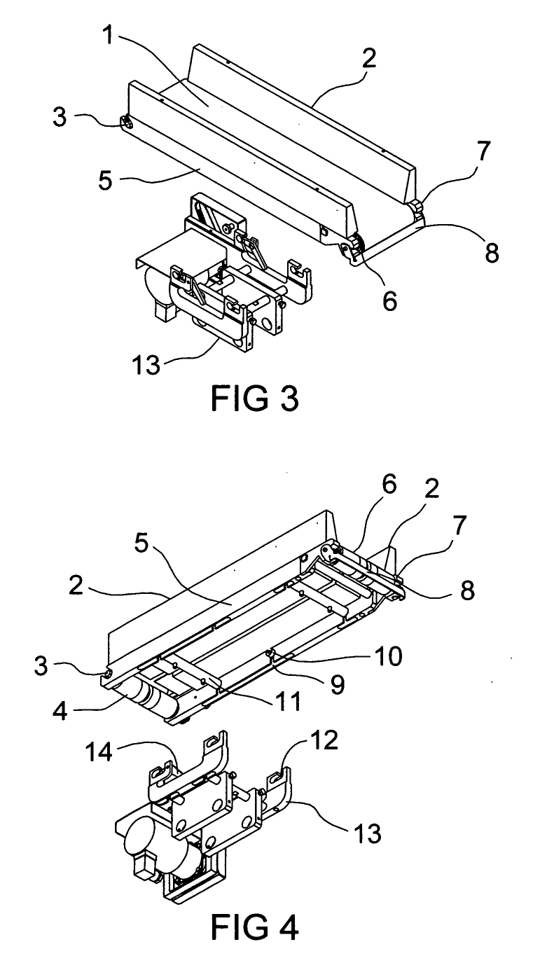

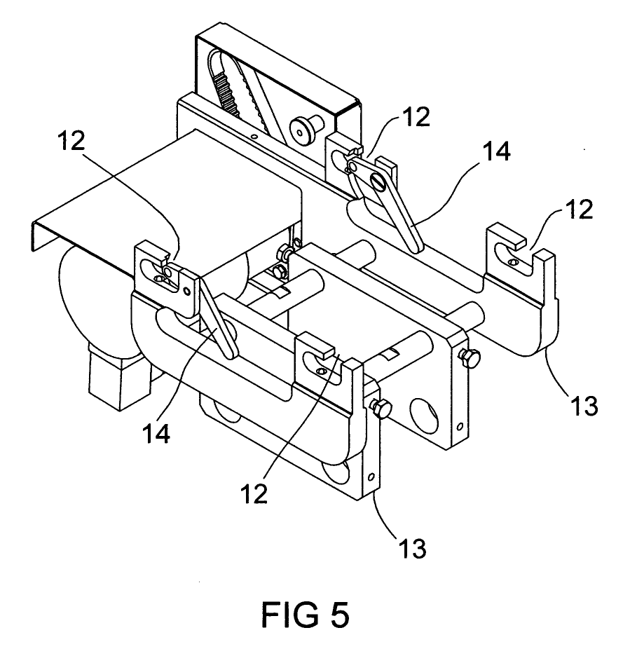

FIGS. 3-5 illustrate the removable feature of the embodiment. The conveyor module is held in place laterally with slots 9 in the underside of the conveyor side plates 5 and held in place vertically by short 10 and long retaining shafts 11 between the conveyor side plates 5 that fit in the machined slots 12 of the conveyor subframe 13. The conveyor is retained longitudinally using retaining fingers 14 that are normally locked under their own weight to prevent the conveyor from becoming detached unexpectedly. To remove the conveyor module, the two retaining fingers 14 are lifted to allow the conveyor side plates 5 to move longitudinally and up from the conveyor subframe 13. When the conveyor module is put back into position, the retaining fingers 14 are moved out of the way by the retaining shafts 10-11 automatically locking the module firmly in place. Since the retaining fingers 14 of this embodiment are of uniform thickness throughout, it is necessary to have the handle portion of the retaining finger 14 longer than the portion which contacts the retaining shafts 10-11 to provide the weight necessary to keep the retaining shafts 10-11 locked while the retaining fingers 14 are in a neutral position.

I claim:

1. A method of conveying product consisting of:
a. a conveyor frame consisting of two parallel side plates each of said side plates having two cylindrical protrusions wherein the axis of said cylindrical protrusions is perpendicular to said parallel side plates,
b. an endless conveyor belt,
c. a fixed position driven belt pulley,
d. a pivotal idler belt pulley wherein pivoting said pivotal idler belt pulley releases tension of said endless conveyor belt,
e. a bracket consisting of two parallel side plates, each of said side plates having two slots for receiving said cylindrical protrusions
f. a pivotal releasing finger wherein the weight of said pivotal releasing finger stops horizontal movement of said conveyor frame and wherein rotating said pivotal releasing finger allows said conveyor frame to slide in the direction of said endless conveyor belt and perpendicular to said direction of said endless conveyor belt whereby said conveyor frame may be removed.
